(19) United States
(12) Patent Application Publication
(10) Pub. No.: US 2018/0216358 A1
(43) Pub. Date: Aug. 2, 2018

(54) THREE-DIMENSIONAL CIRCULATING GARAGE

(71) Applicant: BYD COMPANY LIMITED, Shenzhen (CN)

(72) Inventors: Tian QI, Shenzhen (CN); Jinghua TANG, Shenzhen (CN)

(21) Appl. No.: 15/505,425

(22) PCT Filed: Sep. 14, 2015
(86) PCT No.: PCT/CN2015/089555

§ 371 Date: Feb. 21, 2017

(30) Foreign Application Priority Data
Sep. 15, 2014 (CN) 201420529602.1

(51) Int. Cl. E04H 6/14; E04H 6/16; H01R 39/08

(52) U.S. Cl. CPC E04H 6/14; H01R 39/08; E04H 6/16

(57) ABSTRACT

A three-dimensional circulating garage is provided. The three-dimensional circulating garage includes: a transmission device comprising a plurality of tray supporting plates; a plurality of tray components, each tray component comprising a tray shaft, the tray supporting plate being fitted over each end of the tray shaft, and the tray shaft being rotatable relative to the tray supporting plate; and a plurality of conductive slip rings in one-to-one correspondence with the plurality of tray components, each conductive slip ring comprising a stator and a rotor, the rotor being fitted over the tray shaft and stationary relative to the tray shaft, the stator being fitted over the tray shaft, connected to the tray supporting plate and stationary relative to the tray supporting plate; a cable input terminal disposed on an end surface of the stator facing the tray supporting plate, and a cable output terminal disposed on an end surface of the rotor away from the stator. The three-dimensional circulation garage has the advantages that system failures caused by cable winding are avoided, the installation of other components is free of being affected by the installation of the conductive slip rings, occasions with large current requirements can be met, and there is no need to route the electric cable inside the tray shaft during cable installation.

### CROSS REFERENCE TO RELATED APPLICATIONS

This application is a national phase entry under 35 U.S.C. § 371 of International Application No. PCT/CN2015/089555, filed on Sep. 14, 2015, which claims priority and benefits of Chinese Patent Application No. 201420529602.1 filed with State Intellectual Property Office on Sep. 15, 2014, the entire contents of all of which are incorporated herein by reference.

### FIELD

The present disclosure generally relates to the field of garage and, particularly, relates to a three-dimensional circulating garage.

### BACKGROUND

In the related art, it is inconvenient to install a conductive slip ring into a three-dimensional circulating garage, the mode of connection of the conductive slip ring may be complicated, and the conductive slip ring may have a large occupation. Therefore, it may be unhelpful for installing other elements or devices onto the three-dimensional circulating garage and may affect the storing and charging of a vehicle.

### SUMMARY

Embodiments of the present disclosure seek to solve at least one of the problems existing in the related art to at least some extent.

According to embodiments of the present disclosure, a three-dimensional circulating garage is provided. The three-dimensional circulating garage includes: a transmission device comprising a plurality of tray supporting plates; a plurality of tray components each connected with the transmission device and each comprising a tray shaft, the tray supporting plate being fitted over each end of the tray shaft, and the tray shaft being rotatable relative to the tray supporting plate; a charger disposed on the tray component; a plurality of conductive slip rings in one-to-one correspondence with the plurality of tray components and each comprising a rotor which is fitted over the tray shaft and stationary relative to the tray shaft and a stator which is fitted over the tray shaft and connected to the tray supporting plate and stationary relative to the tray supporting plate; a cable input terminal disposed on an end surface of the stator facing the tray supporting plate and adapted to connect with a power supply, and a cable output terminal disposed on an end surface of the rotor away from the stator and connected with the charger.

With the three-dimensional circulating garage according to embodiments of the present disclosure, as there is a plurality of conductive slip rings, an electric cable may be prevented from winding due to relative rotation between the tray component and the transmission device, and then a system failure caused by winding of electric cables may be avoided, and stability of the three-dimensional circulating garage may be assured. In addition, the stator and the rotor are fitted over the tray shaft, the stator is stationary relative to the tray supporting plate, and the rotor is stationary relative to the tray shaft, so installation of the conductive slip ring wouldn't influence installation of other parts, and space occupation of the conductive slip ring on a length direction of the tray shaft wouldn't be limited. Thus, it is suitable for large current due to some actual needs. Besides, the stator and the rotor have a hollow configuration, the cable input terminal and the cable output terminal are disposed on two ends of the conductive slip ring, when an electric cable is installed, there is no need to route the electric cable inside the tray shaft. Then a manufacturing difficulty of the tray component may be simplified, and a manufacturing cost may be reduced.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

The disclosure will be illustrated with reference to the accompanying drawings, in which:

FIG. 1 is a schematic view of a tray component having a charger and a conductive slip ring in a three-dimensional circulating garage according to an embodiment of the present disclosure;

FIG. 2 is an enlarged schematic view of part H of FIG. 1;

FIG. 3 is a schematic view of a conductive slip ring without a rotation stopping sheet according to an embodiment of the present disclosure;

FIG. 4 and FIG. 5 are schematic views of a conductive slip ring having a rotation stopping sheet from different perspectives according to an embodiment of the present disclosure.

### DETAILED DESCRIPTION

Reference will be made in detail to embodiments of the present disclosure. The same or similar elements and the elements having same or similar functions are denoted by like reference numerals throughout the descriptions. The embodiments described herein with reference to drawings are explanatory, illustrative, and used to generally understand the present disclosure. The embodiments shall not be construed to limit the present disclosure.

In the specification, unless specified or limited otherwise, relative terms such as “center”, “longitudinal”, “lateral”, “width”, “thickness” “front”, “rear”, “right”, “left”, “lower”, “upper”, “vertical”, “above”, “below”, “up”, “top”, “bottom”, “clockwise”, “anticlockwise”, “axial direction”, “radial direction”, “circumferential direction”, as well as derivative thereof (e.g., “downwardly”, “upwardly”, etc.) should be construed to refer to the orientation as then described or as shown in the drawings under discussion. These relative terms are for convenience of description and do not require that the present disclosure be constructed or operated in a particular orientation.

In addition, terms such as “first” and “second” are used herein for purposes of description and are not intended to indicate or imply relative importance or significance. Thus, features limited by “first” and “second” are intended to indicate or imply including one or more than one these features. In the description of the present disclosure, “a plurality of” relates to two or more than two.

In the description of the present disclosure, unless specified or limited otherwise, it should be noted that, terms “mounted,” “connected” “coupled” and “fastened” may be understood broadly, such as permanent connection or detachable connection, electronic connection or mechanical connection, direct connection or indirect connection via intermediary, inner communication or interaction between two elements. Those having ordinary skills in the art should understand the specific meanings in the present disclosure according to specific situations.

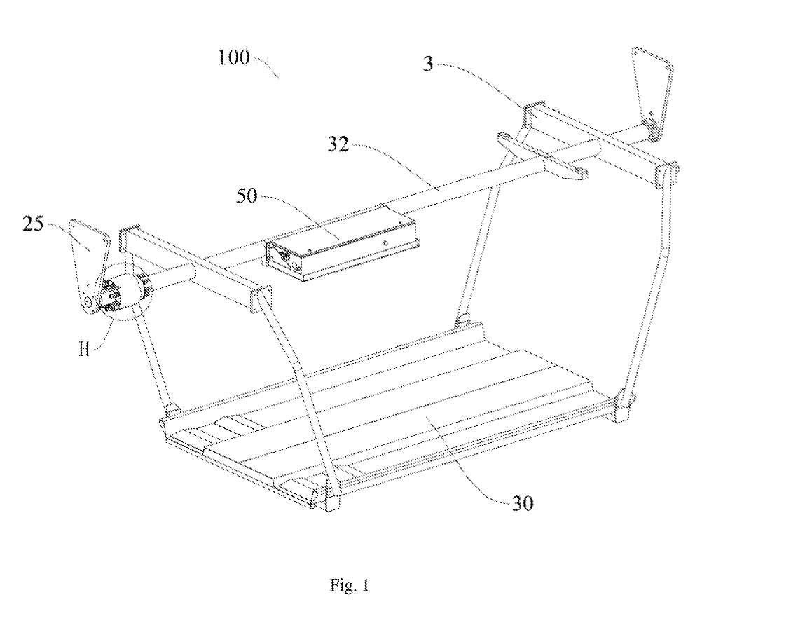

As shown in FIGS. 1-5, a three-dimensional circulating garage 100 is provided according to embodiments of the present disclosure. The three-dimensional circulating garage 100 may be used for storing vehicles, such as an electric vehicle. In addition, the three-dimensional circulating garage 100 according to embodiments of the present disclosure may charge the vehicle stored therein.

In some embodiments, the three-dimensional circulating garage includes: a transmission device; a plurality of tray components 3; and a plurality of conductive slip rings 53. The transmission device includes a plurality of tray supporting plates 25. It should be noted that the transmission device also includes other elements, such as a sprocket and a chain, and the plurality of tray supporting plates 25 is disposed on the chain.

The plurality of tray components 3 each is connected with the transmission device, and the transmission device drives each tray component 3 to move reciprocally up and down in circles. Each tray component 3 includes a tray shaft 32 each end of which a tray supporting plate 25 is fitted over. Each tray shaft 32 is rotatable relative to the tray supporting plate 25 such that each tray component 3 could swing around an axial of the tray shaft in a circumference direction, and a gravity center of each tray component 3 could maintain downwardly due to its own weight and the vehicle's weight when the tray component moves reciprocally up and down in circles. Specifically, two ends of the tray shaft 32 are installed in bearing seats of the tray supporting plate 25 respectively.

It should be noted that, in some embodiments, each tray component 3 further includes a vehicle carrying board 30 used for carrying a vehicle such as a car. Each tray component 3 includes a charger 50 disposed thereon. The charger 50 may be used for charging the vehicle placed on the corresponding vehicle carrying board 30.

In some embodiments, the plurality of conductive slip rings 53 and the plurality of tray components 3 are arranged in one-to-one correspondence with each other. Each conductive slip ring 53 includes a stator 530 and a rotor 531. The rotor 531 is fitted over the tray shaft 32 and stationary relative to the tray shaft 32. Specifically, the rotor 531 is fixed on the tray shaft 32 via a jackscrew 536 such that the rotor 531 is stationary relative to the tray shaft 32.

The stator 530 is fitted over the tray shaft 32 and connected to the tray supporting plate 25, and the stator 530 is stationary relative to the tray supporting plate 25. In other words, the stator 530 is stationary relative to the tray supporting plate 25, and the rotor 531 is stationary relative to the tray shaft 32. When each tray shaft 32 rotates relative to the corresponding tray supporting plate 25, the rotor 531 rotates relative to the stator 530. Thus, an electric current may be prevented from being interrupted while the stator 530 and the rotor 531 are relatively rotating. It should be noted that an electrically connection relationship between the stator 530 and the rotor 531 is well known by those skilled in the art, therefore the detailed description is omitted herein.

In some embodiments, an cable input terminal 534 adapted to connect with the power supply is disposed on an end surface of the stator 530, facing the tray supporting plate 25, and an cable output terminal 535 electrically connected with the charger 50 is disposed on an end surface of the rotor 531, far away from the stator 530. Specifically, a first outside cable connected with the power supply is connected to the cable input terminal 534 such that the conductive slip ring 53 is electrically connected to the power supply, and a second cable connected with the charger 50 is connected to the cable output terminal 535 such that the conductive slip ring 53 is electrically connected to the charger 50.

It should be noted that the three-dimensional circulating garages 100 according to embodiments of the present disclosure further include other elements, such as a fixing component, and a driving device. The driving device may be connected with the transmission device to drive the transmission device so as to drive the tray component 3 to move reciprocally up and down in circles.

With the three-dimensional circulating garage 100 according to embodiments of the present disclosure, as there is the plurality of conductive slip rings 53, an electric cable may be prevented from winding due to relative rotation between the tray component 3 and the transmission device, and then a system failure caused by winding of electric cables may be avoided, and stability of the three-dimensional circulating garage 100 may be assured. In addition, since the stator 530 and the rotor 531 are fitted over the tray shaft 32, the stator 530 is stationary relative to the tray supporting plate 25 and the rotor 531 is stationary relative to the tray shaft 32, installation of the conductive slip ring 53 would not affect installation of other components, and space occupation of the conductive slip ring 53 on a length direction of the tray shaft would not be limited, suitable for large current due to some actual needs. Besides, the stator 530 and the rotor 531 have a hollow configuration, the cable input terminal 534 and the cable output terminal 535 are disposed on two ends of the conductive slip ring 53 and, thus, when an electric cable is installed, there is no need to route the electric cable inside the tray shaft. Then, a manufacturing difficulty of the tray component 3 may be simplified, and a manufacturing cost may be reduced.

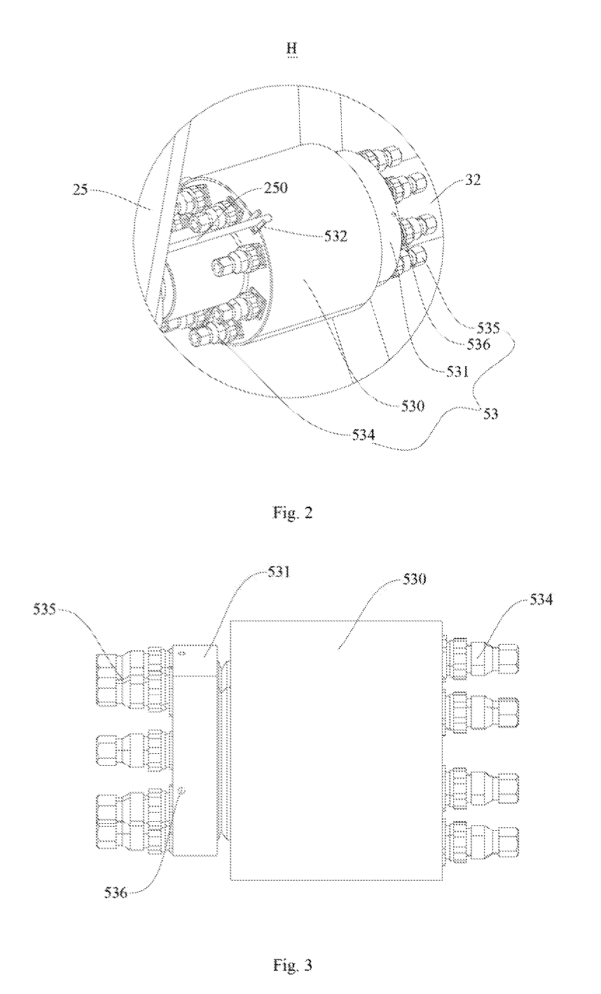

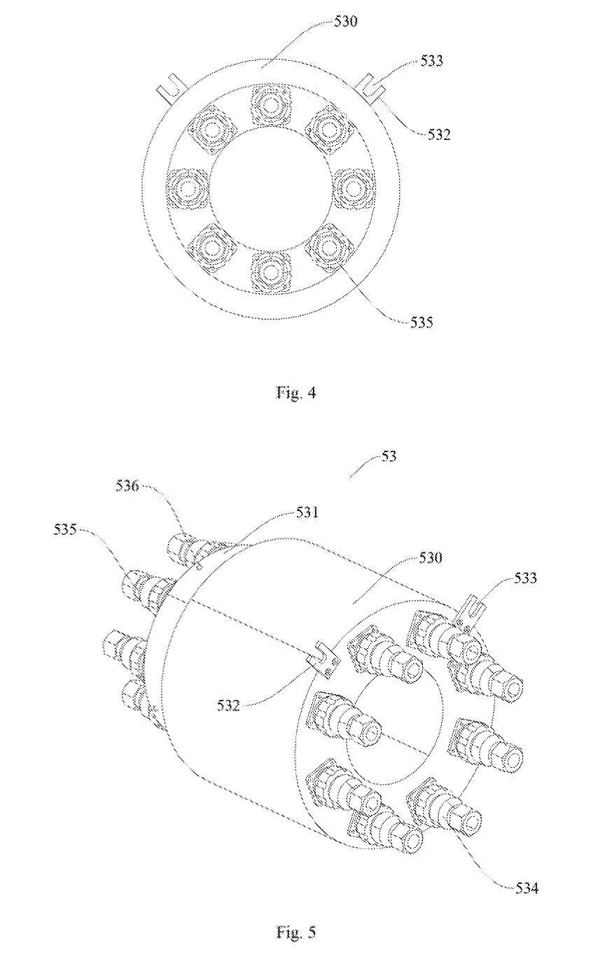

In some embodiments, as shown in FIG. 2, each stator 530 is provided with a rotation stopping sheet 532, and each tray supporting plate 25 is provided with a rotation stopping shifting fork 250. The rotation stopping shifting fork 250 is connected with the rotation stopping sheet 532 such that each stator 530 is stationary relative to the tray supporting plate 25. That is the stator 530 is connected with the tray supporting plate 25 via the rotation stopping sheet 532 and the rotation stopping shifting fork 250 such that an assembling relationship between the stator 530 and the tray supporting plate 25 is simple. In some embodiments, there is a plurality of the rotation stopping sheets 532 and, also, there is a plurality of the rotation stopping shifting fork 250. The plurality of the rotation stopping sheets 532 and the plurality of the rotation stopping shifting fork 250 are in one-to-one correspondence with each other. Then, connection stability between the stator 530 and the tray supporting plate 25 may be improved, and it may be guaranteed that the stator 530 is stationary relative to the tray supporting plate 25. As shown in FIG. 4 and FIG. 5, there are two rotation stopping sheets 532.

As shown in FIG. 1, FIG. 2, FIG. 4 and FIG. 5, in some embodiments, an assembling groove 533 is disposed in the rotation stopping sheet 532, a free end of the rotation stopping shifting fork 250 is fitted with the assembling groove 533 such that the rotation stopping shifting fork 250 may be easily connected to the rotation stopping sheet 532. In some embodiments, the rotation stopping sheet 532 has a rectangle shape, and the inlet of the assembling groove 533 locates on an end surface of the rotation stopping sheet 532 in a radial direction of the stator 530.

In some embodiments, the rotation stopping shifting fork 250 is formed as a cylindrical bar such that the rotation stopping shifting fork 250 may have a simple configuration, and a manufacturing cost may be reduced. In some embodiments, as shown in FIG. 2, FIG. 4 and FIG. 5, the rotation stopping sheet 532 is disposed on an end surface of the stator 530 facing the tray supporting plate 25. The rotation stopping sheet 532 is fixed on the stator 530 via a fastener. For example, in one embodiment, the fastener is a screw.

In some embodiments, each of the cable input terminal 534 and the cable output terminal 535 is configured as an aviation plug. Then it may be easy for installation and inspection, and the conductive slip ring 53 may be prevented from being scraped due to cable damage so as to reduce using cost.

Reference throughout this specification to “an embodiment”, “some embodiments”, “an example”, “a specific example”, or “some examples” means that a particular feature, structure, material, or characteristic described in connection with the embodiment or example is included in at least one embodiment or example of the present disclosure. The appearances of the phrases throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principle and scope of the present disclosure.

What is claimed is:

1. A three-dimensional circulating garage, comprising:
a transmission device comprising a plurality of tray supporting plates;
a plurality of tray components each connected with the transmission device and each comprising a tray shaft, the tray supporting plate being fitted over each end of the tray shaft, and the tray shaft being rotatable relative to the tray supporting plate;
a charger disposed on the tray component;
a plurality of conductive slip rings in one-to-one correspondence with the plurality of tray components and each comprising a rotor which is fitted over the tray shaft and stationary relative to the tray shaft and a stator which is fitted over the tray shaft and connected to the tray supporting plate and stationary relative to the tray supporting plate;
a cable input terminal disposed on an end surface of the stator facing the tray supporting plate and adapted to connect with a power supply, and
a cable output terminal disposed on an end surface of the rotor away from the stator and connected with the charger.

2. The three-dimensional circulating garage of claim 1, wherein the rotor is fixed on the tray shaft via a jackscrew.

3. The three-dimensional circulating garage of claim 1, wherein the stator is provided with a rotation stopping sheet, the tray supporting plate is provided with a rotation stopping shifting-fork, and the rotation stopping shifting-fork is connected with the rotation stopping sheet such that the stator is stationary relative to the corresponding tray supporting plate.

4. The three-dimensional circulating garage of claim 3, wherein an assembling groove is formed in the rotation stopping sheet, and a free end of the rotation stopping shifting-fork is fitted within the assembling groove.

5. The three-dimensional circulating garage of claim 4, wherein the rotation stopping sheet has a rectangle shape, and an inlet of the assembling groove is formed in an end surface of the rotation stopping sheet in a radial direction of the stator.

6. The three-dimensional circulating garage of claim 4, wherein the rotation stopping shifting-fork is formed as a cylindrical bar.

7. The three-dimensional circulating garage of claim 3, wherein a plurality of the rotation stopping sheets are provided.

8. The three-dimensional circulating garage of claim 3, wherein the rotation stopping sheet is disposed on an end surface of the stator facing the tray supporting plate.

9. The three-dimensional circulating garage of claim 8, wherein rotation stopping sheet is fixed on the stator via a fastener.

10. The three-dimensional circulating garage of claim 1, wherein each of cable input terminal and the cable output terminal is configured as an aviation plug.
